(19) United States
(12) Patent Application Publication
(10) Pub. No.: US 2025/0119215 A1
(43) Pub. Date: Apr. 10, 2025

(54) OPTICAL SIGNAL RELAY APPARATUS AND OPTICAL SIGNAL RELAY METHOD

(71) Applicant: NEC Corporation, Tokyo (JP)

(72) Inventor: Tatsunori OMIYA, Tokyo (JP)

(73) Assignee: NEC Corporation, Tokyo (JP)

(21) Appl. No.: 18/883,191

(22) Filed: Sep. 12, 2024

(30) Foreign Application Priority Data
Oct. 6, 2023 (JP) 2023-174078

(51) Int. Cl. H04B 10/29; G02B 6/293; H04J 14/02; H04Q 11/00

(52) U.S. Cl. CPC H04B 10/29; G02B 6/293; H04J 14/0227; H04Q 11/0005; H04Q 2011/0011

(57) ABSTRACT

A wavelength conversion apparatus and a wavelength conversion method capable of suitably performing wavelength conversion in accordance with channel information of an optical signal are provided. Reception means receives a first optical signal of a first wavelength included in a wavelength-multiplexed signal to convert the received first optical signal into an electric signal. Transmission means transmits a second optical signal obtained by modulating a transmission light of a second wavelength based on the electric signal. Channel information acquisition means acquires channel information of the first optical signal. Control means determines, based on the channel information, a reception parameter that the reception means applies to the reception of the first optical signal and a transmission parameter that the transmission means applies to the transmission of the second optical signal, applies the determined reception parameter to the reception means, and applies the determined transmission parameter to the transmission means.

### INCORPORATION BY REFERENCE

This application is based upon and claims the benefit of priority from Japanese patent application No. 2023-174078, filed on Oct. 6, 2023, the disclosure of which is incorporated herein in its entirety by reference.

### TECHNICAL FIELD

The present disclosure relates to an optical signal relay apparatus and an optical signal relay method.

### BACKGROUND ART

As a wavelength-multiplexed (WDM: Wavelength Division Multiplexing) optical network system, a system in which one or more optical signal relay apparatuses are provided between optical transmission apparatuses that perform transmission and reception of optical signals and transmission paths of the optical signals are switched in a flexible manner has been proposed. Regarding this system, in order to efficiently use wavelength resources, a technique for converting wavelengths of optical signals in the optical signal relay apparatus has been known.

As an example of a configuration for converting a wavelength of an optical signal in an optical signal relay apparatus, a wavelength converter for converting an optical input signal into an electric signal and converting the electric signal into an optical output signal is proposed in Patent Literature 1. In this wavelength converter, the optical output signal is converted into a signal having a wavelength different from that of the optical input signal.

In a general WDM optical network system in which the optical signal relay apparatus including the wavelength converter is provided, the optical signal relay apparatus and the like are set after information on the optical signal transmitted through the entire system is known in advance. In the optical signal relay apparatus, for example, a reception parameter to be used for processing for receiving an optical input signal and a transmission parameter to be used for processing for transmitting an optical output signal are suitably set based on the information on the optical signal.

### CITATION LIST

[Patent Literature 1] Published Japanese Translation of PCT International Publication for Patent Application, No. 2017-511036

### SUMMARY

Recently, it has been required that the WDM optical network system meet short-term spot demand in accordance with the development of open cabling and vendor diversification. It has therefore been required to satisfy short-term use in wavelength units.

In order to meet the above demand, it may be possible for a user who uses the wavelength to prepare, for example, a transmitter/receiver so that it can be connected to the WDM optical network system. At this time, the user sets a bandwidth and a signal format of the optical signal in accordance with its application. In this case, however, an administrator of the WDM optical network system is unable to know the bandwidth and the signal format of the optical signal set by the user.

In the wavelength conversion of an optical signal in an optical signal relay apparatus, a parameter to be applied to the reception of the optical signal may be different from a parameter to be applied to the transmission of the optical signal in accordance with a bandwidth and a signal format of the optical signal. Therefore, it is required to know the bandwidth and the signal format of the optical signal of the conversion target and supply parameters for allowing suitable wavelength conversion to be performed to the optical signal relay apparatus.

However, in a case where it is impossible to know the bandwidth and the signal format of the optical signal set by the user in a general WDM optical network system, it is difficult in principle to supply parameters for allowing suitable wavelength conversion to be performed to the optical signal relay apparatus.

An optical signal relay apparatus according to one aspect of the present disclosure includes: reception means for receiving a first optical signal of a first wavelength included in a wavelength-multiplexed signal to convert the received first optical signal into an electric signal; transmission means for transmitting a second optical signal obtained by modulating a transmission light of a second wavelength based on the electric signal; channel information acquisition means for acquiring channel information of the first optical signal; and control means for determining, based on the channel information, a reception parameter that the reception means applies to the reception of the first optical signal and a transmission parameter that the transmission means applies to the transmission of the second optical signal, applying the determined reception parameter to the reception means, and applying the determined transmission parameter to the transmission means.

An optical signal relay method according to one aspect of the present disclosure includes: converting a first optical signal of a first wavelength included in a wavelength-multiplexed signal into an electric signal; transmitting a second optical signal obtained by modulating a transmission light of a second wavelength based on the electric signal; acquiring channel information of the first optical signal; determining, based on the channel information, a reception parameter to be applied to reception of the first optical signal and a transmission parameter to be applied to transmission of the second optical signal; and applying the determined reception parameter to the reception of the first optical signal and applying the determined transmission parameter to the transmission of the second optical signal.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram schematically showing a configuration of an optical signal relay apparatus according to one example embodiment;

FIG. 2 is a block diagram showing a more detailed configuration of the optical signal relay apparatus according to one example embodiment;

FIG. 3 is a diagram showing a first example of acquisition of a bandwidth of an optical input signal;

FIG. 4 is a diagram showing a second example of acquisition of a bandwidth of the optical input signal;

FIG. 5 is a diagram showing an example of acquisition of a signal format of the optical input signal;

FIG. 6 is a flowchart of an operation for setting a reception parameter and a transmission parameter according to the optical signal relay apparatus according to one example embodiment;

FIG. 7 is a diagram showing an example of parameter setting information;

FIG. 8 is a block diagram schematically showing a configuration of the optical signal relay apparatus according to one example embodiment;

FIG. 9 is a sequence diagram of a spectrum measurement operation in the optical signal relay apparatus according to one example embodiment; and

FIG. 10 is a diagram showing transmission bands of a wavelength selection switch.

### EXAMPLE EMBODIMENT

Hereinafter, with reference to the drawings, example embodiments of the present disclosure will be described. Throughout the drawings, the same components are denoted by the same reference symbols and redundant descriptions will be omitted as necessary.

As used herein, “one example embodiment” may refer to any one of the example embodiments described below or to a combination of two or more example embodiments, and its use is not limited to any particular example embodiment.

### First Example Embodiment

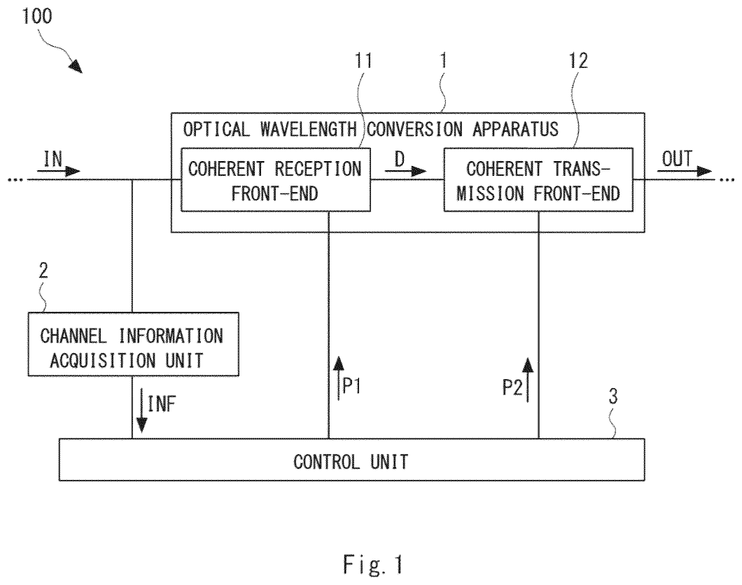

An optical signal relay apparatus according to a first example embodiment will be described. FIG. 1 is a block diagram schematically showing a configuration of the optical signal relay apparatus according to one example embodiment. An optical signal relay apparatus 100 includes an optical wavelength conversion apparatus 1, a channel information acquisition unit 2, and a control unit 3.

In the optical signal relay apparatus 100, an optical input signal IN of a wavelength λ1 is branched into two parts by, for example, an optical branching unit such as an optical coupler. One of the two parts is input to the channel information acquisition unit 2 and the other one of the two parts is input to the optical wavelength conversion apparatus 1. The power of the optical input signal IN output to the channel information acquisition unit 2 may be relatively a small power that is sufficient to acquire channel information of the optical input signal IN. That is, most part of the optical input signal IN may be output to the optical wavelength conversion apparatus 1.

The optical wavelength conversion apparatus 1 converts the optical input signal IN of the wavelength λ1 into an optical output signal OUT of a wavelength λ2. As shown in FIG. 1, the optical wavelength conversion apparatus 1 includes a coherent reception front-end 11 and a coherent transmission front-end 12. The coherent reception front-end 11 converts the optical input signal IN of the wavelength λ1 into a data signal D, which is an electric signal, based on a reception parameter P1 supplied from the control unit 3. The coherent transmission front-end 12 converts the data signal D into the optical output signal OUT of the wavelength λ2 based on a transmission parameter P2 supplied from the control unit 3.

Hereinafter, the wavelength λ1 is also referred to as a first wavelength. The wavelength λ2 is also referred to as a second wavelength. The optical input signal IN is also referred to as a first optical signal. The optical output signal OUT is also referred to as a second optical signal.

The coherent reception front-end, which is one example of a reception unit or reception means of optical signals, may have another configuration as appropriate depending on a signal format and the like of the optical input signal IN. The coherent transmission front-end, which is one example of a transmission unit or transmission means of optical signals, may have another configuration as appropriate depending on a signal format and the like of the optical output signal OUT.

The channel information acquisition unit 2 refers to the input optical input signal IN and acquires a bandwidth and a signal format of the optical input signal IN as channel information INF. The channel information acquisition unit 2 outputs the acquired channel information INF to the control unit 3.

The control unit 3 determines the reception parameter P1 and the transmission parameter P2 based on the channel information INF acquired by the channel information acquisition unit 2. The control unit 3 outputs the determined reception parameter P1 to the coherent reception front-end 11 and outputs the determined transmission parameter P2 to the coherent transmission front-end 12.

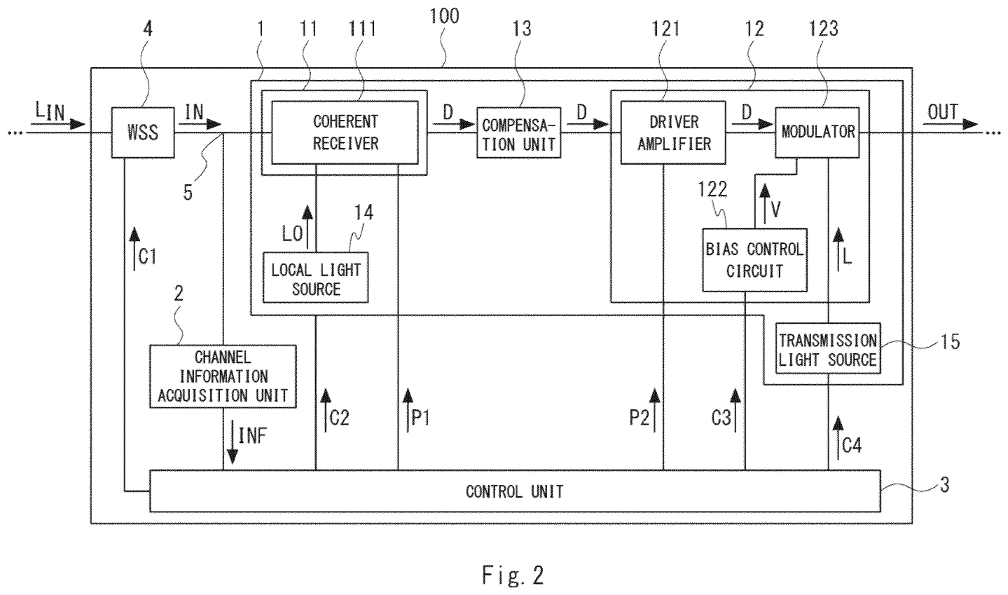

The configuration of the optical signal relay apparatus 100 will be described in more detail. FIG. 2 is a block diagram showing a more detailed configuration of the optical signal relay apparatus according to one example embodiment. In FIG. 2, the optical signal relay apparatus 100 further includes a wavelength selection switch 4 and an optical coupler 5.

The wavelength selection switch 4 transmits, of a wavelength-multiplexed optical signal L_{IN} input to the optical signal relay apparatus 100, the optical input signal IN of the wavelength λ1. The wavelength of the optical signal transmitted through the wavelength selection switch 4 is controlled by a control signal C1 output from the control unit 3. In the drawings, the wavelength selection switch is also referred to as a Wavelength Selective Switch (WSS).

An optical branching unit such as a 1-input 2-output optical coupler 5 is provided between an output of the wavelength selection switch 4 and an input of the optical wavelength conversion apparatus 1. The optical coupler 5 branches the optical input signal IN into two parts. One of the two parts is output to the optical wavelength conversion apparatus 1 and the other one of the two parts is output to the channel information acquisition unit 2.

The optical wavelength conversion apparatus 1 further includes a compensation unit 13, a local light source 14, and a transmission light source 15. The coherent reception front-end 11 includes a coherent receiver 111. The coherent transmission front-end 12 includes a driver amplifier 121, a bias control circuit 122, and a modulator 123.

The local light source 14 outputs a local oscillation light LO of the wavelength λ1 to the coherent receiver 111 in accordance with a control signal C2 from the control unit 3. The transmission light source 15 outputs a transmission light L of the wavelength λ2 to the modulator 123 in accordance with a control signal C4 from the control unit 3.

The coherent receiver 111 converts the optical input signal IN into the data signal D by coherently-detecting the optical input signal IN using the local oscillation light LO. At this time, the coherent receiver 111 adjusts the voltage of the output data signal D based on the reception parameter P1. When the optical input signal IN is a Dual polarization-Binary Phase Shift Keying (DP-BPSK) optical signal, the coherent receiver 111 may be configured, for example, as an integrated coherent receiver composed of a polarized wave separator, a 90° hybrid, a photoelectric converter, and an amplifier.

The compensation unit 13 performs processing for compensating for the data signal D and outputs the data signal D after the compensation to the driver amplifier 121. At this time, the compensation processing performed by the compensation unit 13 may be either analog processing or digital processing.

The driver amplifier 121 amplifies the data signal based on the transmission parameter P2 and outputs the amplified data signal D to the modulator 123. At this time, the driver amplifier 121 adjusts the voltage of the output data signal D based on the transmission parameter P2.

The bias control circuit 122 applies a bias voltage V to the modulator 123 in accordance with a control signal C3 from the control unit 3.

The modulator 123 may be configured, for example, as a quadrature modulator that performs quadrature modulation on a light based on the input signal. The modulator 123 modulates the transmission light L in accordance with the data signal D to output the optical output signal OUT.

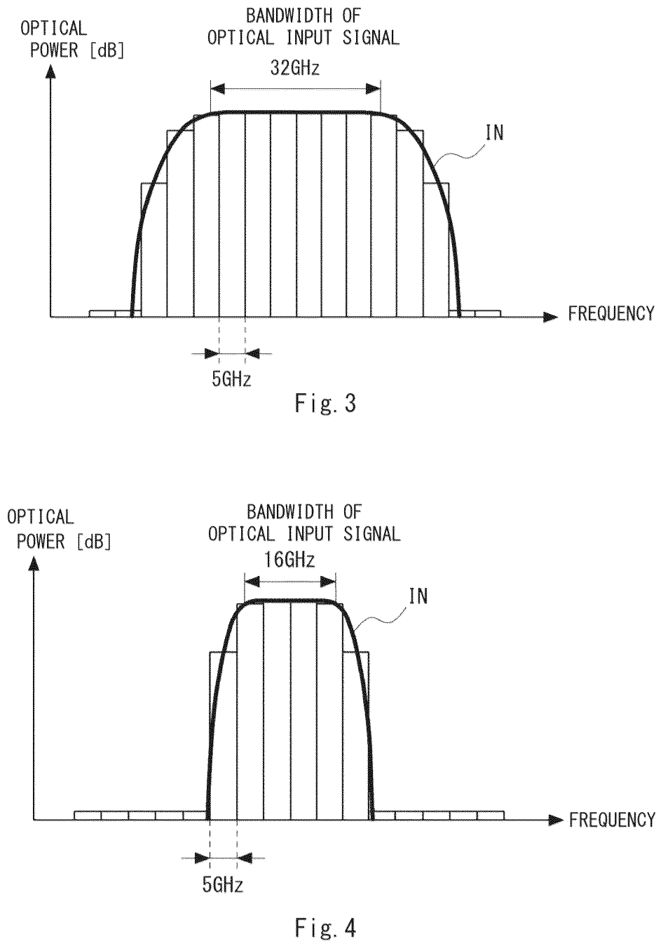

Next, acquisition of a bandwidth, of channel information in the channel information acquisition unit 2, will be described first. FIG. 3 is a diagram showing a first example of acquisition of a bandwidth of the optical input signal. As shown in the solid line in FIG. 3, the actual spectrum of the optical input signal IN is continuous data, and its bandwidth is 32 GHz. However, there is a limitation in the frequency resolution of the channel information acquisition unit 2. In this example, the resolution of spectrum measurement of the channel information acquisition unit 2 is 5 GHz. Therefore, the spectrum of the optical input signal IN measured by the channel information acquisition unit 2 is measured as discrete data, and is measured as a spectrum in a form of a bar graph, as shown in FIG. 3.

The channel information acquisition unit 2 may acquire, for example, the width of a flat part of the peak of the spectrum acquired as the discrete data as the bandwidth. In the example shown in FIG. 3, the spectrum resolution of the channel information acquisition unit 2 is 5 GHz and the bandwidth of the optical input signal IN is determined to be 30 GHz or greater and 40 GHz or smaller.

FIG. 4 is a diagram showing a second example of acquisition of the bandwidth of the optical input signal. In FIG. 4, the band is narrower than that in FIG. 3. In the example shown in FIG. 4, the channel information acquisition unit 2 determines that the bandwidth of the optical input signal IN is 10 GHz or greater and 20 GHz or lower.

Next, acquisition of the signal format of the optical input signal IN will be described. The channel information acquisition unit 2 determines the signal format based on the shape of the measured spectrum of the optical input signal IN. More specifically, the channel information acquisition unit 2 compares the measured spectrum of the optical input signal IN with reference spectra showing shapes of spectra of respective signal formats, and determines the signal format in accordance with a degree of approximation between the spectrum shapes. At this time, the channel information acquisition unit 2 may use any method as appropriate to evaluate the degree of approximation between the spectrum of the optical input signal IN and the reference spectra.

The channel information acquisition unit 2 outputs the channel information INF indicating the bandwidth and the signal format of the optical input signal IN acquired as described above to the control unit 3.

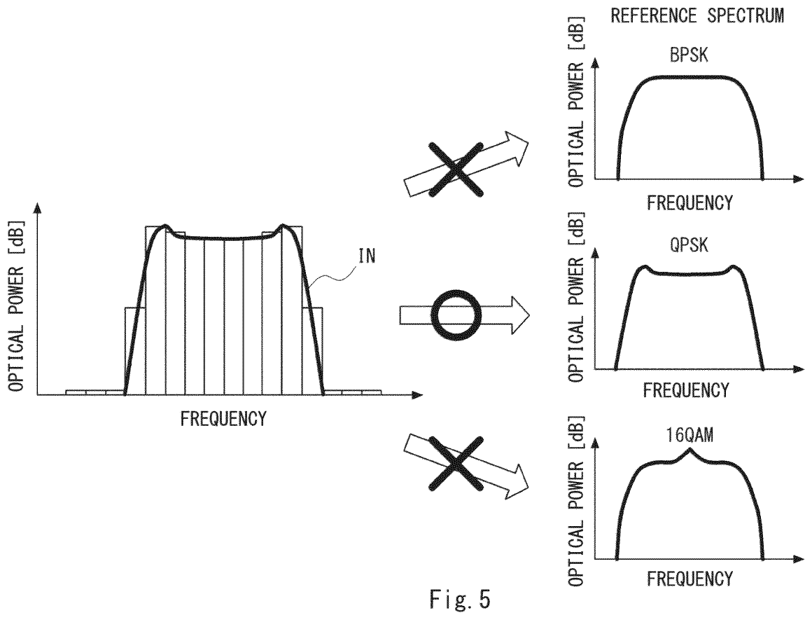

FIG. 5 is a diagram showing an example of acquisition of the signal format of the optical input signal. In this example, the region near the peak of the spectrum of the optical input signal IN acquired as the discrete data has a shape in which the value of a central part becomes slightly smaller than the values at both end parts. This spectrum is compared to each of three reference spectra of BPSK, QPSK (Quadrature Phase Shift Keying), and 16 QAM (Quadrature Amplitude Modulation) shown on the right side of FIG. 5. In this example, since the spectrum of the optical input signal IN is most approximate to the reference spectrum of QPSK, the channel information acquisition unit 2 determines that the signal format of the optical input signal IN is QPSK.

The reference spectra may be held by the channel information acquisition unit 2 in advance. Further, the reference spectra may be stored in various kinds of storage means (not shown) provided in the optical signal relay apparatus 100. In this case, the channel information acquisition unit 2 may load the reference spectra from the storage means as necessary. The reference spectra may be supplied to the channel information acquisition unit 2 or the storage means as appropriate via any communication means.

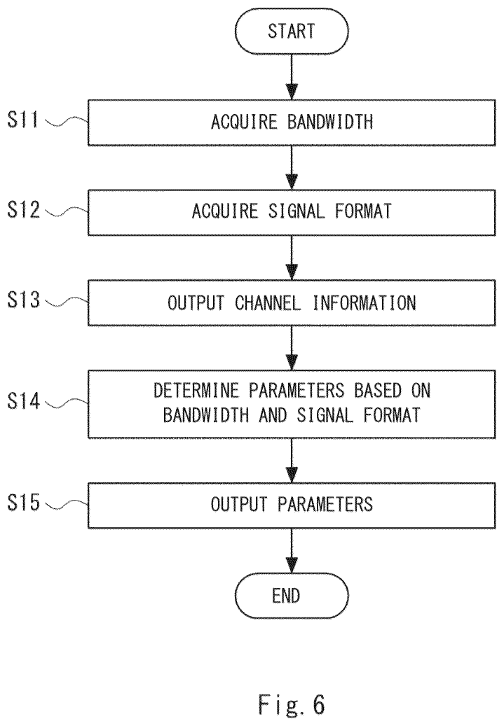

Next, an operation for setting the reception parameter and the transmission parameter in the optical signal relay apparatus 100 will be described. FIG. 6 is a flowchart of the operation for setting the reception parameter and the transmission parameter in the optical signal relay apparatus according to one example embodiment.

### Step S11

The channel information acquisition unit 2 acquires the bandwidth of the optical input signal IN as described above.

### Step S12

The channel information acquisition unit 2 acquires the signal format of the optical input signal IN as described above.

### Step S13

The channel information acquisition unit 2 outputs the channel information INF indicating the bandwidth and the signal format of the optical input signal IN that have been acquired to the control unit 3.

### Step S14

The control unit 3 collates the bandwidth and the signal format of the optical input signal IN indicated by the channel information INF with parameter setting information. Then, the control unit 3 acquires the reception parameter and the transmission parameter suitable for the bandwidth and the signal format of the optical input signal IN.

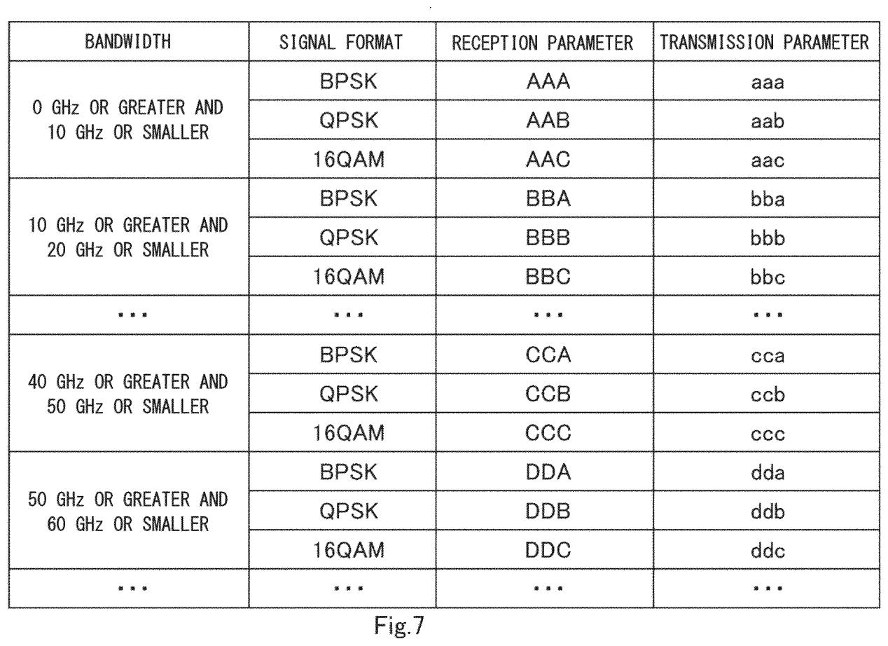

FIG. 7 is a diagram showing an example of the parameter setting information. At this time, the parameter setting information may be supplied as table information indicating a correspondence between the bandwidth and the signal format of the optical signal and the reception parameter and the transmission parameter. Accordingly, the control unit 3 may load the reception parameter and the transmission parameter corresponding to the bandwidth and the signal format of the optical input signal IN as appropriate.

The parameter setting information may be held by the control unit 3 in advance. Further, the parameter setting information may be stored in various kinds of storage means (not shown) provided in the optical signal relay apparatus 100. In this case, the control unit 3 may read the parameter setting information from the storage means as necessary. The parameter setting information may be supplied to the control unit 3 and the storage means as appropriate via any communication means.

### Step S15

The control unit 3 outputs the acquired reception parameter P1 and the acquired transmission parameter P2 to the coherent receiver 111 and the driver amplifier 121, respectively. Accordingly, the coherent receiver 111 is able to perform suitable reception processing in accordance with the bandwidth and the signal format of the optical input signal IN. Further, the driver amplifier 121 may perform suitable transmission processing in accordance with the bandwidth and the signal format of the optical input signal IN and those of the optical output signal OUT.

As described above, according to the optical signal relay apparatus 100, it is possible to suitably set control information used in optical wavelength conversion in the optical wavelength conversion apparatus 1 based on the bandwidth and the signal format of the optical input signal IN. Accordingly, even when the user of the WDM optical network system sets the bandwidth and the signal format of the optical signal in accordance with its application, the optical signal relay apparatus 100 is able to implement suitable optical wavelength conversion in accordance with the bandwidth and the signal format that have been set.

### Second Example Embodiment

In the first example embodiment, the channel information acquisition unit 2 capable of acquiring the spectrum of the optical input signal IN by itself is described as channel information acquisition means for acquiring channel information on the optical input signal IN. However, the channel information acquisition means may have another configuration. In this example embodiment, a configuration in which an optical power measurement unit is provided in place of the channel information acquisition unit 2 and channel information is acquired by channel information acquisition means formed of an optical power measurement unit and a control unit will be described. Further, in this configuration, the spectrum of the optical input signal IN is acquired by performing processing for measuring the optical power a plurality of times by the optical power measurement unit and the control unit.

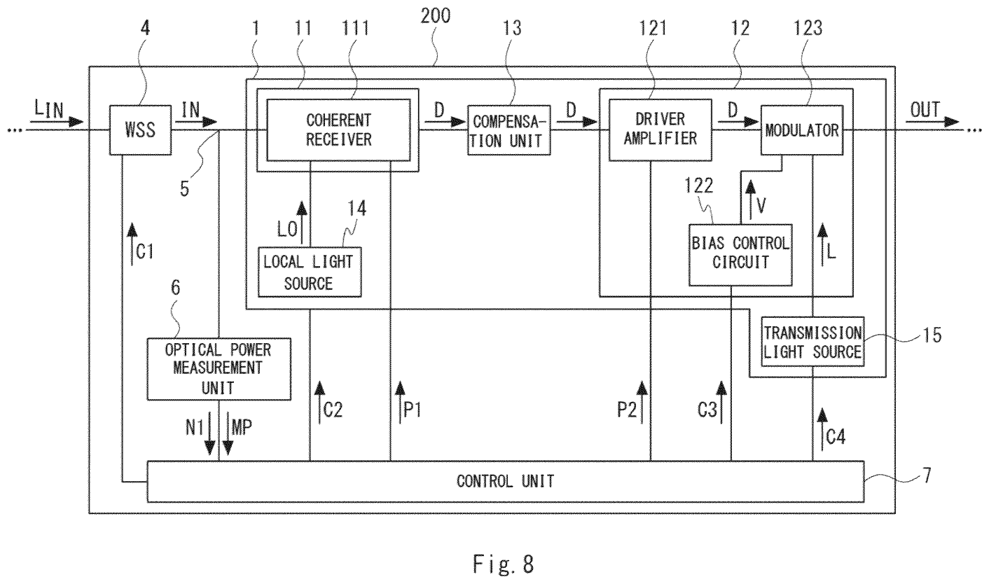

FIG. 8 is a block diagram schematically showing a configuration of an optical signal relay apparatus according to one example embodiment. An optical signal relay apparatus 200 has a configuration in which the channel information acquisition unit 2 and the control unit 3 of the optical signal relay apparatus 100 are replaced by an optical power measurement unit 6 and a control unit 7, respectively.

The optical power measurement unit 6 measures an optical power of an optical input signal IN branched in an optical coupler 5. Then the optical power measurement unit 6 outputs a measured value MP to the control unit 7.

The control unit 7 acquires the spectrum of the optical input signal IN by controlling the transmission wavelength of the wavelength selection switch 4 and receiving the result of the measurement measured in the optical power measurement unit 6. Further, the control unit 7 acquires channel information based on the spectrum of the optical input signal IN, like in the channel information acquisition unit 2 of the optical signal relay apparatus 100.

Since the other configurations of the optical signal relay apparatus 200 are similar to those of the optical signal relay apparatus 100, the redundant description will be omitted.

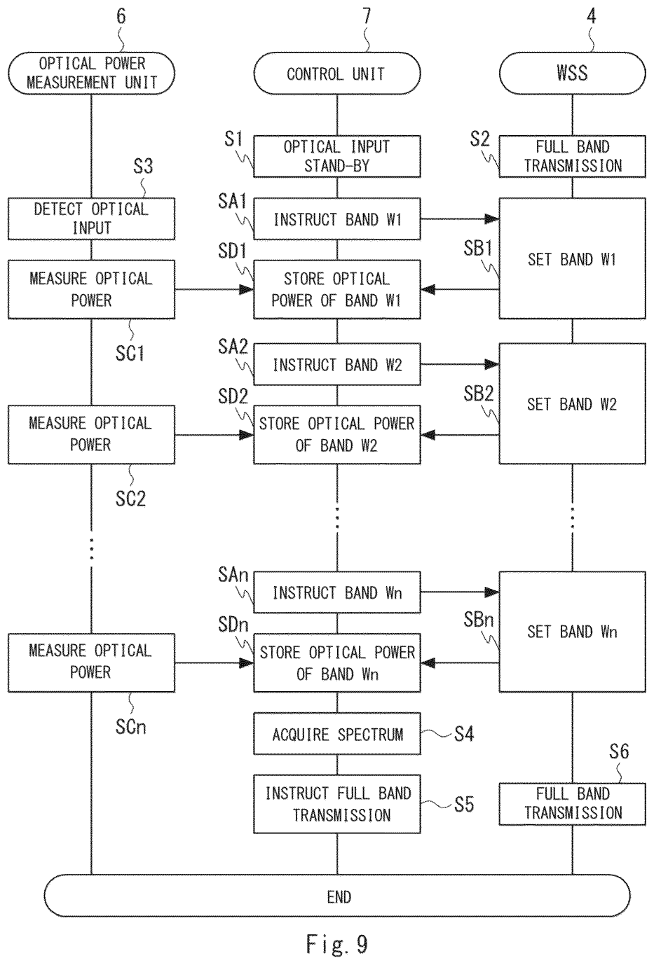

Next, a spectrum measurement operation in the optical signal relay apparatus 200 will be described. FIG. 9 is a sequence diagram of the spectrum measurement operation in the optical signal relay apparatus according to one example embodiment.

### Step S1

In the initial state of the spectrum measurement, the control unit 7 is in a standby state until when the optical input signal IN is input to the optical power measurement unit 6.

### Step S2

In the initial state of the spectrum measurement, the wavelength selection switch 4 is in a state in which it transmits the full band of the input optical signal. This may be achieved by the control unit 7 sending an instruction to the wavelength selection switch 4 by the control signal C1 in advance.

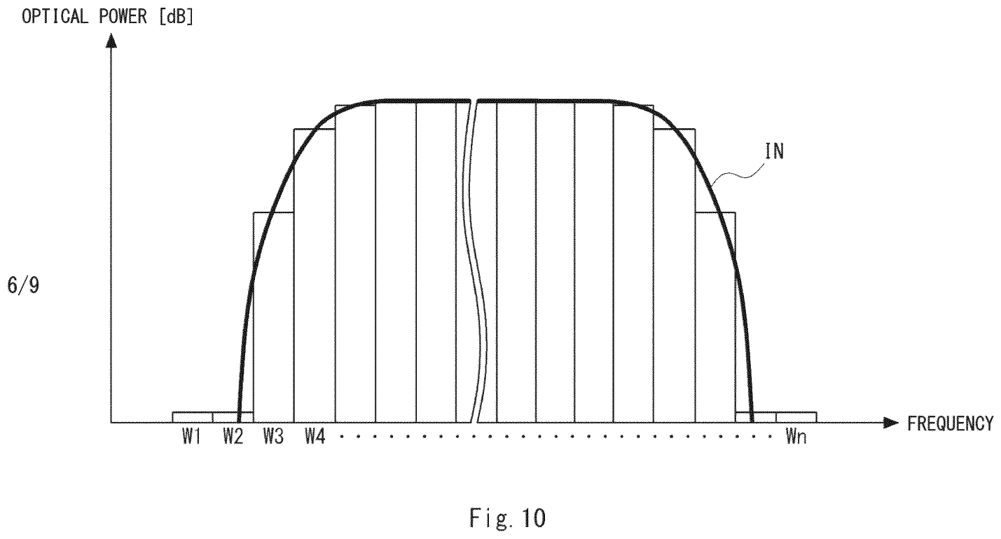

In the following, the optical power of the optical input signal IN is measured and recorded while the transmission bands of the wavelength selection switch 4 are switched. Now, the transmission bands of the wavelength selection switch 4 will be described. FIG. 10 is a diagram showing the transmission bands of the wavelength selection switch. In this example embodiment, the full band of the optical input signal IN is divided into two or more n bands W1-Wn of a predetermined bandwidth. The optical signal relay apparatus 200 measures and record the optical power of the optical input signal IN for each of the bands W1-Wn.

### Step SA1

The control unit 7 first sends an instruction to the wavelength selection switch 4 by a control signal C1 in such a way that the transmission band of the wavelength selection switch 4 becomes the band W1.

### Step SB1

The wavelength selection switch 4 sets the transmission band to the band W1 in accordance with the control signal C1.

### Step SC1

The optical power measurement unit 6 measures the optical power of the optical input signal IN transmitted through the wavelength selection switch 4. Then the optical power measurement unit 6 notifies the control unit 7 of the measured value MP of the optical power.

### Step SD1

The control unit 7 records the measured value MP of the optical power sent from the optical power measurement unit 6. At this time, the control unit 7 may be stored in various kinds of storage means (not shown) provided in the optical signal relay apparatus 100. Note that the control unit 7 may record the measured value MP of the optical power at a desired timing and read out the measured value MP of the optical power that has been recorded.

### Steps SA2-SAn, SB2-SBn, SC2-SCn, and SD2-SDn

In the following, the optical power of the optical input signal IN transmitted through the wavelength selection switch 4 is repeatedly measured and recorded while the transmission bands of the wavelength selection switch 4 are switched. Accordingly, the optical signal relay apparatus 200 is able to perform setting of the transmission band of the wavelength selection switch 4 and measurement and recording of the optical power of the optical input signal IN transmitted through the wavelength selection switch 4 for each of the bands W1-Wn.

### Step S4

After the setting of the transmission band of the wavelength selection switch 4 and the measurement and the recording of the optical power of the optical input signal IN transmitted through the wavelength selection switch 4 are completed for all the bands W1-Wn, the control unit 7 reads out the results of the measurement and acquires the spectrum of the optical input signal IN as a bar graph of the optical power of the bands W1-Wn.

### Step S5

After the spectrum is acquired, the control unit 7 sends an instruction to the wavelength selection switch 4 by the control signal C1 in such a way that the wavelength selection switch 4 transmits the full band of the input optical signal.

### Step S6

The wavelength selection switch 4 sets the transmission band to the full band in accordance with the control signal C1.

While the spectrum measurement operation has been described above, other operations performed by the optical signal relay apparatus 200 are similar to those of the optical signal relay apparatus 100 except that the control unit 7 acquires the channel information, not the channel information acquisition unit 2, in the optical signal relay apparatus 200. Therefore, a redundant description of the operation will be omitted.

As described above, according to the optical signal relay apparatus 200, it is possible to acquire the spectrum of the optical input signal IN using the measured value of the optical power in the optical power measurement unit 6. The optical power measurement unit 6 is generally provided in the optical signal relay apparatus in order to measure the optical power of the input optical signal. Therefore, by performing the aforementioned spectrum measurement operation, in a general optical signal relay apparatus as well, it is possible to measure the spectrum of the optical input signal IN without requiring any particular change in the configuration. As a result, in the optical signal relay apparatus 200 having a configuration of the general optical signal relay apparatus as well, it is possible to suitably set control information to be used for optical wavelength conversion in the optical wavelength conversion apparatus 1 based on the bandwidth and the signal format of the optical input signal IN, like in the optical signal relay apparatus 100.

### Other Example Embodiments

While the present disclosure has been described with reference to the example embodiments, the present disclosure is not limited to the aforementioned example embodiments. Various changes that may be understood by those skilled in the art within the scope of the present disclosure can be made to the configurations and the details of the present disclosure. Then, each of the example embodiments may be combined with other example embodiments as appropriate.

For example, in the optical signal relay apparatus 200 described above, the control unit 7 acquires channel information. Therefore, the reference spectra may be held by the control unit 7 in advance. Further, the reference spectra may be stored in various kinds of storage means (not shown) provided in the optical signal relay apparatus 200. In this case, the control unit 7 may load the reference spectra from the storage means as necessary. The reference spectra may be supplied to the control unit 7 and the storage means as appropriate via any communication means.

The channel information acquisition unit 2 may have, for example, a desired configuration capable of acquiring channel information from a spectrum of input light.

The optical power measurement unit 6 may be, for example, any optical power measurement means such as a photodiode.

While BPSK, QPSK, and 16 QAM have been mentioned as the signal format in the aforementioned example embodiments, this is merely an example. The signal format of the optical input signal IN may be any signal format other than those stated above.

Each of the drawings is merely an example for describing one or more example embodiments. Each of the drawings is not associated with only one particular example embodiment and may instead be associated with one or more other example embodiments. Those skilled in the art will appreciate that various features or steps described with reference to any one of the drawings may be combined with features or steps shown in one or more other drawings in order to produce, for example, example embodiments that are not explicitly illustrated or described. Not all the features or steps shown in any one of the figures to describe illustrative example embodiments are necessary, and some of the features or steps may be omitted. The order of the steps shown in any one of the figures may be changed as appropriate.

The whole or part of the example embodiments disclosed above can be described as, but not limited to, the following supplementary notes.

(Supplementary Note 1) An optical signal relay apparatus including:
reception means for receiving a first optical signal of a first wavelength included in a wavelength-multiplexed signal to convert the received first optical signal into an electric signal;
transmission means for transmitting a second optical signal obtained by modulating a transmission light of a second wavelength based on the electric signal;
channel information acquisition means for acquiring channel information of the first optical signal; and
control means for determining, based on the channel information, a reception parameter that the reception means applies to the reception of the first optical signal and a transmission parameter that the transmission means applies to the transmission of the second optical signal, applying the determined reception parameter to the reception means, and applying the determined transmission parameter to the transmission means.
   (Supplementary Note 2) The optical signal relay apparatus according to Supplementary Note 1, in which the channel information acquisition means:
measures a spectrum of the first optical signal;
acquires, based on the measured spectrum, a bandwidth and a signal format of the first optical signal as the channel information; and
outputs the acquired channel information to the control means.
   (Supplementary Note 3) The optical signal relay apparatus according to Supplementary Note 1, further including:
wavelength selection means for transmitting, from the wavelength-multiplexed signal, an optical signal of a band instructed by the control means, in which
the channel information acquisition means includes:
   the control means; and
   optical power measurement means for measuring optical power of the optical signal that has been transmitted through the wavelength selection means and outputting a result of the measurement to the control means,
the optical power measurement means measures the optical power of the optical signal transmitted through the wavelength selection means while the control means is switching a transmission band of the wavelength selection means in a plurality of bands narrower than a band of the first optical signal, whereby the control means measures a spectrum of the first optical signal in the plurality of bands, and
the control means acquires, based on the measured spectrum, a bandwidth and a signal format of the first optical signal as the channel information.
   (Supplementary Note 4) The optical signal relay apparatus according to Supplementary Note 2 or 3, in which
the channel information acquisition means:
   compares the measured spectrum with each of a plurality of reference spectra indicating reference of spectra of optical signals of a plurality of signal formats; and
   acquires a signal format corresponding to the reference spectrum most approximate to the measured spectrum as the signal format of the first optical signal.
      (Supplementary Note 5) The optical signal relay apparatus according to any one of Supplementary Notes 2 to 4, in which the control means refers to information indicating a correspondence between a bandwidth and a signal format of an optical signal and a reception parameter and a transmission parameter, and specifies the reception parameter and the transmission parameter corresponding to the bandwidth and the signal format of the first optical signal.
      (Supplementary Note 6) The optical signal relay apparatus according to any one of Supplementary Notes 1 to 5, or 2, in which
the reception means is configured as coherent optical reception front-end means, and
the transmission means is configured as coherent optical transmission front-end means.
   (Supplementary Note 7) The optical signal relay apparatus according to Supplementary Note 6, in which the coherent optical reception front-end means adjusts a voltage of the electric signal in accordance with the transmission parameter.
   (Supplementary Note 8) The optical signal relay apparatus according to Supplementary Note 6, in which
the coherent optical transmission front-end means includes:
   amplification means for amplifying the electric signal based on the transmission parameter; and
   modulation means for modulating the transmission light based on the amplified electric signal and outputting the second optical signal.
      (Supplementary Note 9) The optical signal relay apparatus according to any one of Supplementary Notes 1 to 8, further including compensation means for compensating for the electric signal output by the reception means and outputting the compensated electric signal to the transmission means.
      (Supplementary Note 10) An optical signal relay method including:
converting a first optical signal of a first wavelength included in a wavelength-multiplexed signal into an electric signal;
transmitting a second optical signal obtained by modulating a transmission light of a second wavelength based on the electric signal;
acquiring channel information of the first optical signal;
determining, based on the channel information, a reception parameter to be applied to reception of the first optical signal and a transmission parameter to be applied to transmission of the second optical signal; and
applying the determined reception parameter to the reception of the first optical signal and applying the determined transmission parameter to the transmission of the second optical signal.

The first and second example embodiments can be combined as desirable by one of ordinary skill in the art.

While the disclosure has been particularly shown and described with reference to example embodiments thereof, the disclosure is not limited to these example embodiments. It will be understood by those of ordinary skill in the art that various changes in form and details may be made therein without departing from the spirit and scope of the present disclosure as defined by the claims.

What is claimed is:

1. An optical signal relay apparatus comprising:
a reception unit configured to receive a first optical signal of a first wavelength included in a wavelength-multiplexed signal to convert the received first optical signal into an electric signal;
a transmission unit configured to transmit a second optical signal obtained by modulating a transmission light of a second wavelength based on the electric signal;
a channel information acquisition unit configured to acquire channel information of the first optical signal; and
a control unit configured to determine, based on the channel information, a reception parameter that the reception unit applies to the reception of the first optical signal and a transmission parameter that the transmission unit applies to the transmission of the second optical signal, apply the determined reception parameter to the reception unit, and apply the determined transmission parameter to the transmission unit.

2. The optical signal relay apparatus according to claim 1, wherein
the channel information acquisition unit:
measures a spectrum of the first optical signal;
acquires, based on the measured spectrum, a bandwidth and a signal format of the first optical signal as the channel information; and
outputs the acquired channel information to the control unit.

3. The optical signal relay apparatus according to claim 1, further comprising:
a wavelength selection unit configured to transmit, from the wavelength-multiplexed signal, an optical signal of a band instructed by the control unit, wherein
the channel information acquisition unit comprises:
the control unit; and
an optical power measurement unit configured to measure optical power of the optical signal that has been transmitted through the wavelength selection unit and output a result of the measurement to the control unit,
the optical power measurement unit measures the optical power of the optical signal transmitted through the wavelength selection unit while the control unit is switching a transmission band of the wavelength selection unit in a plurality of bands narrower than a band of the first optical signal, whereby the control unit measures a spectrum of the first optical signal in the plurality of bands, and
the control unit acquires, based on the measured spectrum, a bandwidth and a signal format of the first optical signal as the channel information.

4. The optical signal relay apparatus according to claim 2, wherein
the channel information acquisition unit:
compares the measured spectrum with each of a plurality of reference spectra indicating reference of spectra of optical signals of a plurality of signal formats; and
acquires a signal format corresponding to the reference spectrum most approximate to the measured spectrum as the signal format of the first optical signal.

5. The optical signal relay apparatus according to claim 2, wherein the control unit refers to information indicating a correspondence between a bandwidth and a signal format of an optical signal and a reception parameter and a transmission parameter, and specifies the reception parameter and the transmission parameter corresponding to the bandwidth and the signal format of the first optical signal.

6. The optical signal relay apparatus according to claim 1, wherein
the reception unit is configured as a coherent optical reception front-end, and
the transmission unit is configured as a coherent optical transmission front-end.

7. The optical signal relay apparatus according to claim 6, wherein the coherent optical reception front-end adjusts a voltage of the electric signal in accordance with the transmission parameter.

8. The optical signal relay apparatus according to claim 6, wherein
the coherent optical transmission front-end comprises:
an amplifier configured to amplify the electric signal based on the transmission parameter; and
a modulator configured to modulate the transmission light based on the amplified electric signal and output the second optical signal.

9. The optical signal relay apparatus according to claim 1, further comprising a compensation unit configured to compensate for the electric signal output by the reception unit and output the compensated electric signal to the transmission unit.

10. An optical signal relay method comprising:
converting a first optical signal of a first wavelength included in a wavelength-multiplexed signal into an electric signal;
transmitting a second optical signal obtained by modulating a transmission light of a second wavelength based on the electric signal;
acquiring channel information of the first optical signal;
determining, based on the channel information, a reception parameter to be applied to reception of the first optical signal and a transmission parameter to be applied to transmission of the second optical signal; and
applying the determined reception parameter to the reception of the first optical signal and applying the determined transmission parameter to the transmission of the second optical signal.
